(19) United States
(12) Patent Application Publication
(10) Pub. No.: US 2015/0207559 A1
(43) Pub. Date: Jul. 23, 2015

(54) VSAT SYSTEM FOR HYBRID OPERATION OF STAR-MESH NETWORK AND METHOD FOR CONTROLLING THEREOF

(71) Applicant: Electronics and Telecommunications Research Institute, Daejeon (KR)

(72) Inventors: Joon Gyu RYU, Daejeon (KR); Man Kyu PARK, Daejeon (KR); Deock Gil OH, Daejeon (KR); Nam Young KIM, Daejeon (KR); Myoung Soo AHN, Daejeon (KR)

(21) Appl. No.: 14/328,965

(22) Filed: Jul. 11, 2014

(30) Foreign Application Priority Data
Jan. 21, 2014 (KR) 10-2014-0007094

(51) Int. Cl. H04B 7/155

(52) U.S. Cl. CPC H04B 7/15542

(57) ABSTRACT

A first terminal according to the present invention is a first terminal among a plurality of terminals which is connected to a district center network management device in a VSAT (very small aperture terminal) system, including: a communication unit which connects the first terminal to the district center network management device through a star network; and a control unit which creates SCPC call establishment request information, transmits the created SCPC call establishment request information to the district center network management device through the communication unit, and performs SCPC connection with another terminal based on SCPC call establishment information which is transmitted from the district center network management device in response to the transmitted SCPC call establishment request information when SCPC (single channel per carrier) connection is desired to be performed with another terminal among the plurality of terminals.

### CROSS-REFERENCE TO RELATED APPLICATIONS

This application claims priority to and the benefit of Korean Patent Application No. 10-2014-0007094 filed in the Korean Intellectual Property Office on Jan. 21, 2014, the entire contents of which are incorporated herein by reference.

### TECHNICAL FIELD

The present invention relates to a VSAT system for hybrid operation of a star-mesh network and a method for controlling the same and more particularly, to a VSAT system for hybrid operation of a star-mesh network which provides SCPC connection between terminals by checking an available frequency from a district center network management device and forming a mesh network for the SCPC connection between the terminals through the checked available frequency when any one terminal requests SCPC (single channel per carrier) connection with another terminal among a plurality of terminals which is connected to the district center network management device based on a star network such as a DVB-S2/RCS 1, 2 and a method for controlling the same.

### BACKGROUND ART

A VSAT (very small aperture terminal) is a satellite earth station with a small antenna having a diameter of 0.6 to 1.8 m.

The VSAT is classified into a star shaped VSAT, a TDMA (time divisional multiple access) VSAT and a DAMA (demand assigned multiple access) VSAT in accordance with a type of communication. Among these, the star shaped VSAT adopts a method in which a signal passes through a large hub station and is used for minor communication such as a POS (point of sale) or credit check of a credit card through a route of a VSAT station→a hub station→a public communication network→a user terminal.

In such a VSAT, a bandwidth needs to be actively changed in accordance with requirements of a user according to various types of user traffic such as voice communication and video conference service and various satellite access technologies such as a dynamic TDMA or SCPC needs to be provided for real time multimedia data transmission.

### SUMMARY OF THE INVENTION

The present invention has been made in an effort to provide a VSAT system for hybrid operation of a star-mesh network which forms a mesh network for providing an SCPC link between terminals based on a star network using DVB-S2/RCS 1, 2 and a method for controlling the same.

The present invention has also been made in an effort to provide a VSAT system for hybrid operation of a star-mesh network which provides a call processing procedure for SCPC connection between terminals in a VSAT system which is operated on a star network and a method for controlling the same.

An exemplary embodiment of the present invention provides a first terminal among a plurality of terminals which is connected to a district center network management device in a VSAT (very small aperture terminal) system, the first terminal including: a communication unit which connects the first terminal to the district center network management device through a star network; and a control unit which creates SCPC call establishment request information, transmits the created SCPC call establishment request information to the district center network management device through the communication unit, and performs SCPC connection with another terminal based on SCPC call establishment information which is transmitted from the district center network management device in response to the transmitted SCPC call establishment request information when intending to perform SCPC (single channel per carrier) connection with another terminal among the plurality of terminals.

According to an aspect of the present invention, the star network may be a DVB-S2 or DVB-RCS network.

According to an aspect of the present invention, the SCPC call establishment request information may include at least one of identification information of the first terminal which includes the control unit, identification information of another terminal to be SCPC connected, network usage starting time information, network usage time information, and a requested bandwidth.

According to an aspect of the present invention, the SCPC call establishment information may include at least one of session information, identification information of the first terminal which is a requesting terminal, identification information of another terminal which is a target terminal, information representing whether to be approved, network usage starting time information, network usage time information, SCPC network information of the first terminal. SCPC network information of the other terminal, information on a used frequency of the first terminal, information on a used frequency of the other terminal, information on a frequency bandwidth, information on DVB-S2 modulation/demodulation, and information on maximum output power.

According to an aspect of the present invention, when a predetermined event happens, the control unit may release the SCPC connection with another terminal under the control of the district center network management device.

According to an aspect of the present invention, the predetermined event may include a case when a predetermined network usage time expires and a case when any one terminal among the SCPC connected terminals transmits an SCPC call releasing request to the district center network management device.

Another exemplary embodiment of the present invention provides a district center network management device which is connected to a plurality of terminals in a VSAT system, the device including: a communication unit which connects the district center network management device to the plurality of terminals through a star network and receives SCPC call establishment request information which is transmitted from a first terminal among the plurality of terminals; and a control unit which creates SCPC call establishment notice information based on the received SCPC call establishment request information, transmits the created SCPC call establishment notice information to a second terminal which is an SCPC call establishment target terminal through the communication unit, allocates an SCPC network resource for an SCPC link between the first terminal and the second terminal based on the SCPC call establishment approval information which is transmitted from the second terminal and an available frequency in the VSAT system in response to the transmitted SCPC call establishment notice information, and transmits the created SCPC call establishment information to the first terminal and the second terminal through the communication unit.

According to an aspect of the present invention, the SCPC call establishment notice information may include at least one of session information, identification information of the second terminal which is a target terminal, network usage starting time information, and network usage time information.

According to an aspect of the present invention, the SCPC call establishment approval information may include session information and information representing whether to be approved.

According to an aspect of the present invention, when a predetermined event happens, the control unit may create SCPC call release notice information in order to release SCPC connection between the first terminal and the second terminal which are SCPC connected and transmit the created SCPC call release notice information to the first terminal and the second terminal, through the communication unit.

According to an aspect of the present invention, the control unit may receive information indicating that the SCPC call release is completed which is transmitted from the first terminal and the second terminal in response to the transmitted SCPC call release notice information, through the communication unit and then collect the allocated SCPC network resource for the SCPC link between the first terminal and the second terminal.

Yet another exemplary embodiment of the present invention provides a control method of a first terminal among a plurality of terminals which is connected to a district center network management device in a VSAT system, the method including: connecting the first terminal to the district center network management device based on a star network, through a communication unit; creating SCPC call establishment request information, through a control unit, when intending to perform SCPC connection with another terminal among the plurality of terminals; transmitting the created SCPC call establishment request information to the district center network management device, through the communication unit; and performing SCPC connection with the other terminal based on the SCPC call establishment information which is transmitted from the district center network management device in response to the transmitted SCPC call establishment request information, through the control unit.

According to an aspect of the present invention, the method may further include: releasing the SCPC connection with the other terminal in association with the district center network management device, through the control unit, when a predetermined event happens; and transmitting information indicating that SCPC call release is completed to the district center network management device, through the communication unit.

Still another exemplary embodiment of the present invention provides a control method of a district center network management device which is connected to a plurality of terminals in a VSAT system, the method including: connecting the district center network management device to the plurality of terminals through a star network, through a communication unit; creating SCPC call establishment notice information based on SCPC call establishment request information which is transmitted from a first terminal among the plurality of terminals, through a control unit; transmitting the created SCPC call establishment notice information to a second terminal which is an SCPC call establishment target terminal, through the communication unit; allocating an SCPC network resource for an SCPC link between the first terminal and the second terminal based on SCPC call establishment approval information which is transmitted from the second terminal and an available frequency in the VSAT system in response to the transmitted SCPC call establishment notice information, through the control unit; creating SCPC call establishment information, through the control unit; and transmitting the created SCPC call establishment information to the first terminal and the second terminal, through the communication unit.

According to an aspect of the present invention, the method may further include: creating SCPC call release notice information for releasing the SCPC connection between the first terminal and the second terminal which are SCPC connected, through the control unit, when a predetermined event happens; transmitting the created SCPC call release notice information to the first terminal and the second terminal, through the communication unit; and receiving information indicating that the SCPC call release is completed which is transmitted from the first terminal and the second terminal in response to the transmitted SCPC call release notice information, through the communication unit and then collecting the allocated SCPC network resource for the SCPC link between the first terminal and the second terminal, through the control unit.

A VSAT system for hybrid operation of a star-mesh network and a method for controlling the same according to the exemplary embodiment of the present invention may efficiently provide data communication and/or video communication in a satellite communication system by forming a mesh network for providing a terminal to terminal SCPC link based on a star network using DVB-S2/RCS 1, 2.

VSAT system for hybrid operation of a star-mesh network and a method for controlling the same according to the exemplary embodiment of the present invention may provide a call processing procedure for terminal to terminal SCPC connection in a VSAT system which is operated on a star network to stably provide real time multimedia data transmission and improve overall system operating efficiency.

### BRIEF DESCRIPTION OF TIE DRAWINGS

FIG. 1 is a diagram illustrating a configuration of a VSAT system according to an exemplary embodiment of the present invention.

FIG. 1 is a diagram illustrating a configuration of a first terminal according to an exemplary embodiment of the present invention.

FIG. 3 is a diagram illustrating a configuration of a second terminal according to an exemplary embodiment of the present invention.

FIG. 4 is a diagram illustrating a configuration of a district center network management device according to an exemplary embodiment of the present invention.

FIG. 5 is a signal flowchart illustrating a communication process of a VSAT system for hybrid operation of a star-mesh network according to a first exemplary embodiment of the present invention.

FIG. 6 is a flowchart illustrating a control method of a first terminal for hybrid operation of a star-mesh network according to a second exemplary embodiment of the present invention.

FIG. 7 is a flowchart illustrating a control method of a second terminal for hybrid operation of a star-mesh network according to a third exemplary embodiment of the present invention.

FIG. 8 is a flowchart illustrating a control method of a district center network management device for hybrid operation of a star-mesh network according to a fourth exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It should be noted that technical terminologies used in the present invention are merely used to describe a specific exemplary embodiment but are not intended to limit the present invention. Further, the technical terminologies which are used in the present invention should be interpreted to have meanings that are generally understood by those with ordinary skill in the art to which the present invention pertains, unless specifically defined to have different meanings in the present invention, but not be interpreted as an excessively comprehensive meaning or an excessively restricted meaning. Further, if a technical terminology used in the present invention is an incorrect technical terminology which does not precisely describe the spirit of the present invention, the technical terminology should be replaced with and understood as a technical terminology which may be correctly understood by those skilled in the art. Further, a general terminology used in the present invention should be interpreted as defined in a dictionary or in accordance with the context, but not be interpreted as an excessively restricted meaning.

A singular form used in the present invention may include a plural form unless it has a clearly opposite meaning in the context. Terminologies such as “be configured by” or “include” in the present invention should not be interpreted to necessarily include all of plural components or plural steps described in the present invention, but should be interpreted not to include some of the components or steps or to further include additional components or steps.

Terminologies including an ordinal number such as first or second which is used in the present invention may be used to explain components, but the components are not limited by the terminologies. The terminologies are used only fir distinguishing one component from another component. For example, without departing from the scope of the present invention, the first component may be referred to as the second component, and similarly, the second component may also be referred to as the first component.

Hereinafter, exemplary embodiments according to the present invention will be described in detail with reference to the accompanying drawings, and the same or similar components are denoted by the same reference numerals regardless of reference numerals, and a repeated description thereof will be omitted.

In describing the present invention, when it is determined that a detailed description of a related publicly known technology may obscure the gist of the present invention, the detailed description thereof will be omitted. Further, it is noted that the accompanying drawings are used just for easily appreciating the spirit of the present invention and it should not be interpreted that the spirit of the present invention is limited by the accompanying drawings.

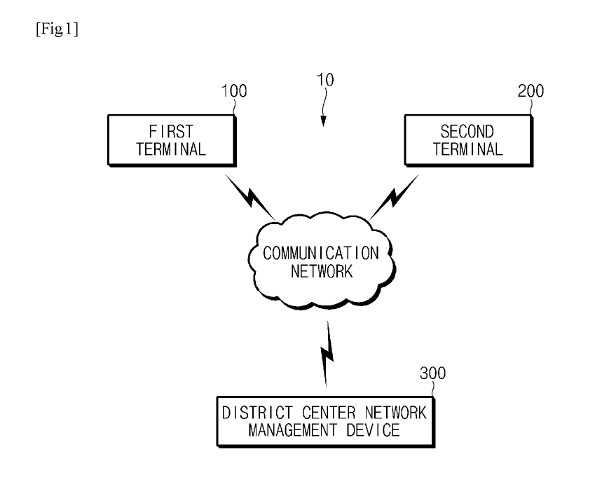

FIG. 1 is a diagram illustrating a configuration of a VSAT system 10 according to an exemplary embodiment of the present invention.

As illustrated in FIG. 1, a VSAT system 10 includes a plurality of terminals such as a first terminal 100 and a second terminal 200 and a district center network management device 300. However, all the components of the VSAT system 10 illustrated in FIG. 1 are not essential components, but the VSAT system 10 may be implemented by more components or less components than the components illustrated in FIG. 1.

In order to perform a terminal to terminal SCPC link between specific terminals among a plurality of terminals 100 and 200 which is connected to the district center network management device 300 based on a star network using a DVB-S2/RCS 1, 2,/an application program which is installed in advance is executed in the first terminal 100 which is one of the specific terminal and an SCPC call connection with the second terminal 200 which is another specific terminal is requested to the district center network management device 300. Thereafter, the district center network management device 300 checks frequencies (or resources) of the entire VSAT system 10 which is being managed and allocates some of available frequencies based on the checked frequencies as a resource (for example, an SCPC network resource) for the SCPC call connection between the terminals 100 and 200. Thereafter, the SCPC connection/link between the terminals 100 and 200 is performed through the SCPC network resource which is allocated by the district center network management device 300.

As illustrated in FIG. 2, the first terminal 100 includes a first communication unit 110, a first storing unit 120, and a first control unit 130. However, all the components of the first terminal 100 illustrated in FIG. 2 are not essential components, but the first terminal 100 may be implemented by more components or less components than the components illustrated in FIG. 2.

The first communication unit 110 connects the first terminal 100 with an arbitrary internal component or at least one arbitrary external terminal through a wired/wireless communication network to communicate each other. In this case, the arbitrary external terminal may include a plurality of other terminals and the district center network management device 300. Here, a wireless Internet technology may include a WLAN (wireless LAN), a Wi-Fi, a Wibro (wireless broadband), Wimax (world interoperability for microwave access), HSDPA (high speed downlink packet access), IEEE 802.16, LTE (long term evolution), or WMBS (wireless mobile broadband service). Further, a near field communication technology may include Bluetooth, RFID (radio frequency identification), IrDA (infrared data association). UWB (ultra wideband), ZigBee, NFC (near field communication), USC (ultra sound communication), and VLC (visible light communication). Further, a wired communication technology may include PLC (power line communication), USB communication, Ethernet, serial communication, or an optical/coaxial cable.

The first communication unit 110 includes a communication module (not illustrated) for forming a star network such as a DVB-S2 (digital video broadcasting over satellite 2) or a DVB-RCS (digital video broadcasting return channel by satellite) with another terminal (for example, terminal 200 or 300).

The first communication unit 110 includes a communication module (not illustrated) for forming a mesh network such as an SCPC (single channel per carrier) with other terminals.

For example, the first communication unit 110 may include a DVB-S2 reception module for receiving a forward link and a DVB-S2 reception module for SCPC reception, a DVB-RCS 1 or 2 based transmission module, and a DVB-S2 based transmission module.

The first storing unit 120 stores data and programs required for operating the first terminal 100.

The first storing unit 1 stores various user interfaces UI and graphic user interfaces GUI.

The first storing unit 120 may include at least one storing medium of a flash memory type, a hard disk type, a multimedia card micro type, a card type memory (for example, an SD or XD) memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the first terminal 100 may operate a web storage which performs a storing function of the first storing unit 120 on the Internet or operate in association with the web storage.

The first control unit 130 controls the entire operation of the first terminal 100.

First, the first control unit 130 accesses (or is connected to/logs on) the district center network management device 300 through the DVB-S2 or DVB-RCS network. That is, the first control unit 130 receives (or collects) satellite network information including an NIT (network information table), a PMT (program map table), an NCR (network clock reference), an SPT (satellite position table), an SCT (superframe composition table), a FCT2 (frame composition table 2), a BCT (RL broadcast configuration table), a TIM-B (terminal information message-broadcast), a TBTP2 (terminal burst time plan 2), or a CMT (correction message table) which is transmitted from the district center network management device 300 through the first communication unit 110. Thereafter, the first control unit 130 requests to log on the district center network management device 300 through the first communication unit 120 in order to form a star network such as the VB-S2 or the DVB-RCS. Next, the district center network management device 300 receives a log-on request of the first control unit 130 and performs authentication of the terminal (for example, the first terminal 100) based on the received log-on request. Next, after normally performing the authentication, the district center network management device 300 transmits TIM-U (terminal information message unicast) setting data to the first terminal 100. Next, the first control unit 130 receives the TIM-U setting data which is transmitted from the district center network management device 300 through the first communication unit 110 and performs MF-TDMA (multi frequency-time division multiple access) synchronization with the district center network management device 300 based on the received TIM-U setting data. Next, after successfully performing the star network connection with the district center network management device 300, the first control unit 130 transmits/receives a traffic such as STB (short traffic burst) or LTB (long traffic burst) to/from the district center network management device 300 through the first communication unit 110.

As described above, the first control unit 130 communicates with (or logs on/is connected to/accesses) the district center network management device 300 through the star network such as the DVB-S2 or the DVB-RCS by the first communication unit 110.

After completing the star network connection between the first control unit 130 and the district center network management device 300, the first control unit 130 transmits identification information (for example, including an ID or an MAC address of the terminal) of the first terminal 100, SCPC network information (for example, including a subnet address of the terminal), or SCPC service information (for example, including protocol information or port information) to the district center network management device 300 through the first communication unit 110.

When the first control unit 130 desires to perform the SCPC connection (or the SCPC link) with another terminal (for example, the second terminal 200) which accesses the district center network management device 300 through the star network while accessing the district center network management device 300 through the star network, if an application program (for example, an SCPC agent program) which is installed in advance in the first terminal 100 is executed, the first control unit 130 receives information on a plurality of terminals (for example, including the first terminal 100 and the second terminal 200), which is connected to the district center network management device 300, which is transmitted from the district center network management device 300 through the first communication unit 110 and then displays the received information on the plurality of terminals which is connected to the district center network management device 300 through the executed application program.

When a specific terminal (or information on the specific terminal, for example, the second terminal 200) is selected from displayed information on the plurality of terminals which is connected to the district center network management device 300, the first control unit 130 creates SCPC call establishment request information (or SCPC connection establishment request information) based on the information on the selected specific terminal. Here, the SCPC call establishment request information includes identification information of the first terminal 100, identification information of the second terminal 200 which is the other terminal to be SCPC connected, network usage starting time information, network usage time information, or a requested bandwidth.

The first control unit 130 transmits the created SCPC call establishment request information to the district center network management device 300 through the first communication unit 110.

The first control unit 130 receives the SCPC call establishment information (or the SCPC connection establishment information) which is transmitted from the district center network management device 300 through the first communication unit 110 in response to the transmitted SCPC call establishment request information. Here, the SCPC call establishment information includes session information, identification information of the first terminal 100 which is a requesting terminal, identification information of the second terminal 200 which is a target terminal, information representing whether to be approved, network usage starting time information, network usage time information, SCPC network information (for example, including a subnet address of the terminal) of the first terminal 100 which is a requesting terminal, SCPC network information of the second terminal 200 which is a target terminal, information on a used frequency of the first terminal 100 which is a requesting terminal, information on a used frequency of the second terminal 200 which is a target terminal, information on a frequency bandwidth, information on DVB-S2 modulation/demodulation, and information on maximum output power.

The first control unit 130 performs a terminal to terminal communication function through the SCPC connection (or SCPC call/network/access/log-on) with the second terminal 200 which is a target terminal for the SCPC connection through the first communication unit 110 based on the received SCPC call establishment information.

When a predetermined event happens, the first control unit 130 releases (ends) the SCPC connection with the second terminal 200 which is a target terminal under the control (or management) of the district center network management device 300. Here, the predetermined event includes a case when a predetermined network usage time expires or a case when any one terminal among the SCPC connected terminals transmits an SCPC call releasing request to the district center network management device 300.

That is, when the usage time of the SCPC call expires (or ends) based on the network usage starting time information and the network usage time information which are included in the SCPC call establishment information, the district center network management device 300 creates SCPC call release notice information (for example, including session information, identification information of the first terminal 100 which is an SCPC call requesting terminal and identification information of the second terminal 200 which is a target terminal) and transmits the created SCPC call release notice information to the first terminal 100 and the second terminal 200. Next, the first terminal 100 and the second terminal 200 complete (or perform) SCPC call release based on the SCPC call release notice information which is transmitted from the district center network management device 300. In this case, even after releasing the SCPC connection between the first terminal 100 and the second terminal 200, the star network between the first terminal 100 and the district center network management device 300 is continuously maintained.

When the first terminal 100 between the first terminal 100 and the second terminal 200 which are connected by the SCPC call requests to release the SCPC call, the first control unit 130 creates SCPC call release request information (for example, including the session information, the identification information of the first terminal 100, and the identification information of the second terminal 200) and transmits the created SCPC call release request information to the district center network management device 300 through the first communication unit 110. Next, the district center network management device 300 creates SCPC call release notice information based on the SCPC call release request information which is transmitted from the first control unit 130 and transmits the created SCPC call release notice information to the first terminal 100 and the second terminal 200. Next, the first terminal 100 and the second terminal 200 complete (or perform) SCPC call release based on the SCPC call release notice information which is transmitted from the district center network management device 300.

After completing the SCPC call release, the first control unit 130 transmits the SCPC call release completion information to the district center network management device 300 through the first communication unit 110 to notify (or inform) that the SCPC call release is completed.

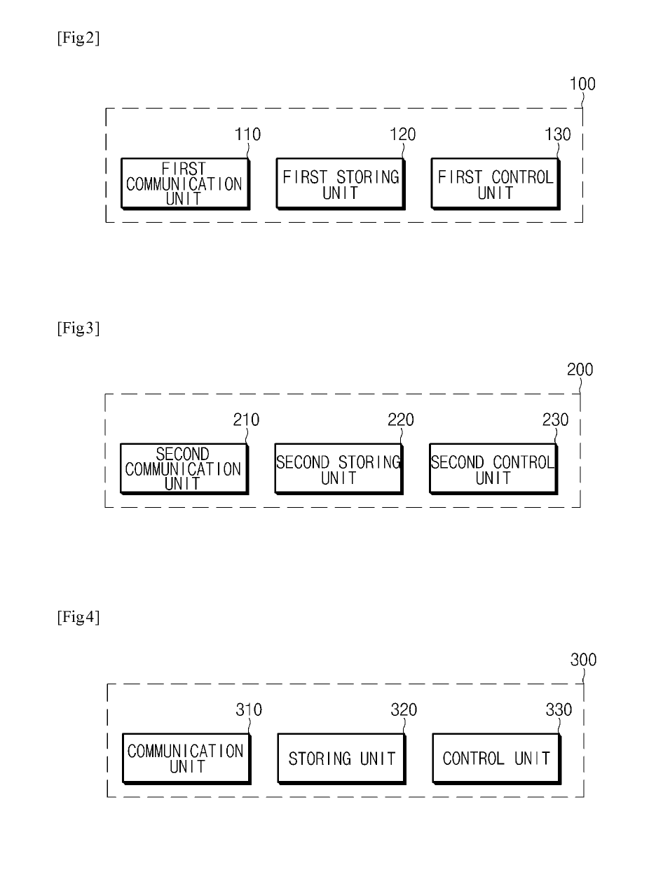

As illustrated in FIG. 3, the second terminal 200 includes a second communication unit 210, a second storing unit 220, and a second control unit 230. However, all the components of the second terminal 200 illustrated in FIG. 3 are not essential components, but the second terminal 200 may be implemented by more components or less components than the components illustrated in FIG. 3.

Basic functions of the second communication unit 210, the second storing unit 220, and the second control unit 230 illustrated in FIG. 3 correspond to the functions of the first communication unit 110, the first storing unit 120, and the first control unit 130 illustrated in FIG. 2 and the description thereof will be omitted.

The second control unit 230 controls the entire operation of the second terminal 200.

First, the second control unit 230 accesses (or is connected to/logs on) the district center network management device 300 through the DVB-S2 or DVB-RCS network.

That is, by the same manner as the first control unit 130 which has been described above, the second control unit 230 communicates with (or logs on/is connected to/accesses) the district center network management device 300 through the star network such as the DVB-S2 or the DVB-RCS by the second communication unit 210.

After completing the star network connection between the second control unit 230 and the district center network management device 300, the second control unit 230 transmits identification information (for example, including an ID (identifier) or an MAC address of the terminal) of the second terminal 200, SCPC network information (for example, including a subnet address of the terminal), or SCPC service information (for example, including protocol information or port information) to the district center network management device 300 through the second communication unit 210.

The second control unit 230 receives SCPC call establishment notice information which is transmitted from the district center network management device 300 through the second communication unit 210 while maintaining the star network connection between the second control unit 230 and the district center network management device 300. Here, the SCPC call establishment notice information includes session information (or session ID/session identification information), identification information of the second terminal 200 which is a target terminal, network usage starting time information, or network usage time information.

The second control unit 230 creates SCPC call establishment approval information in response to the received SCPC call establishment notice information and transmits the created SCPC call establishment approval information to the district center network management device 300 through the second communication unit 210. Here, the SCPC call establishment approval information includes session information, and information representing whether to be approved (for example, including approval permission and approval rejection).

The second control unit 230 receives the SCPC call establishment information (or the SCPC connection establishment information) which is transmitted from the district center network management device 300 through the second communication unit 210 in response to the transmitted SCPC call establishment approval information. Here, the SCPC call establishment information includes session information, identification information of the first terminal 100 which is a requesting terminal, identification information of the second terminal 200 which is a target terminal, information representing whether to be approved, network usage starting time information, network usage time information, SCPC network information (for example, including a subnet address of the terminal) of the first terminal 100 which is a requesting terminal, SCPC network information of the second terminal 200 which is a target terminal, information on a used frequency of the first terminal 100 which is a requesting terminal, information on a used frequency of the second terminal 200 which is a target terminal, information on a frequency bandwidth, information on DVB-S2 modulation/demodulation, and information on maximum output power.

The second control unit 230 performs terminal to terminal communication function through the SCPC connection with the first terminal 100 which is a requesting terminal for the SCPC connection through the second communication unit 210 based on the received SCPC call establishment information.

When a predetermined event happens, the second control unit 230 releases (or ends) the SCPC connection with the first terminal 100 which is a requesting terminal under the control (or management) of the district center network management device 300. Here, the predetermined event includes a case when a predetermined network usage time expires or a case when any one terminal among the SCPC connected terminals transmits an SCPC call releasing request to the district center network management device 300. In this case, even after releasing the SCPC connection between the first terminal 100 and the second terminal 200, the star network between the second terminal 200 and the district center network management device 300 is continuously maintained.

After completing the SCPC call release, the second control unit 230 transmits the SCPC call release completion information to the district center network management device 300 through the second communication unit 210 to notify (or inform) that the SCPC call release is completed.

In the above exemplary embodiment, it has been described that the SCPC call connection with the first terminal 100 is performed in accordance with the request for SCPC call connection in the first terminal 100 and the SCPC call connection request in the second terminal 200 but the present invention is not limited thereto and the function of the first terminal 100 may be performed in the second terminal 200 and the function of the second terminal 200 may be performed in the first terminal 100.

As illustrated in FIG. 4, the district center network management device 300 includes a communication unit 310, a storing unit 320, and a control unit 330. However, all the components of the district center network management device 300 illustrated in FIG. 4 are not essential components, but the district center network management device 300 may be implemented by more components or less components than the components illustrated in FIG. 4.

The communication unit 310 connects the district center network management device 300 with an arbitrary internal component or at least one arbitrary external terminal through a wired/wireless communication network to communicate each other. In this case, the arbitrary external terminal may be a plurality of terminals including the first terminal 100 and the second terminal 200. Here, the wireless Internet technology may include a wireless LAN (WLAN), WiFi, Wibro, Wimax, HSDPA, IEEE 802.16, LTE (long term evolution), or WMBS (wireless mobile broadband service). Further, a near field communication technology may include Bluetooth, RFID (radio frequency identification), IrDA (infrared data association), UWB (ultra wideband), ZigBee, NFC (near field communication), USC (ultra sound communication), and VLC (visible light communication). Further, a wired communication technology may include PLC (power line communication), USB communication, Ethernet, serial communication, or an optical/coaxial cable.

The communication unit 310 includes a communication module (not illustrated) for forming a star network such as a DVB-S2 or a DVB-RCS with another terminal (for example, terminal 100 or 200).

The communication unit 310 includes a communication module (not illustrated) for forming a mesh network such as an SCPC with other terminals.

For example, the communication unit 310 may include a DVB-S2 reception module for receiving a forward link, a DVB-S2 reception module for SCPC reception, a DVB-RCS 1 or 2 based transmission module, and a DVB-S2 based transmission module.

The storing unit 320 stores data and programs required for operating the district center network management device 300.

The storing unit 320 stores various user interfaces UI and graphic user interfaces GUI.

The storing unit 320 may include at least one storing medium of a flash memory type, a hard disk type, a multimedia card micro type, a card type memory (for example, an SD or XD) memory), a magnetic memory, a magnetic disk, an optical disk, a RAM, an SRAM, a ROM, an EEPROM, and a PROM. Further, the district center network management device 300 may operate a web storage which performs a storing function of the storing unit 320 on the Internet or operate in association with the web storage.

The storing unit 320 stores information (or satellite network information) on a satellite network which is included in the VSAT system 10. Here, the satellite network information includes various information related with the satellite network such as NIT, RMT, NCR, SPT, SCT, FCT2, BCT, TIM-B, TBTP2, or CMT.

The storing unit 320 stores a real-time frequency (or resource) condition in the VSAT system (or entire satellite network) 10.

The control unit 330 controls a general operation of the district center network management device 300.

The control unit 330 performs a log-on (or access/connection) management function for one or more (or a plurality of) terminals (for example, including the first terminal 100 and the second terminal 200) which try the access through the DVB-S2 or DVB-RCS network.

The control unit 330 receives SCPC call establishment request information which is transmitted from the first terminal 100 through the communication unit 310. Here, the SCPC call establishment request information includes identification information of the first terminal 100, identification information of the second terminal 200 which is the other terminal to be SCPC connected, network usage starting time information, network usage time information, or a requested bandwidth.

That is, when the first terminal 100 desires to perform the SCPC connection (or the SCPC link) with another terminal (for example, the second terminal 200) which accesses the district center network management device 300 through the star network while accessing the district center network management device 300 through the star network, if an application program which is installed in advance in the first terminal 100 is executed to access the district center network management device 300, the control unit 330 transmits information on the plurality of terminals (for example, including the first terminal 100 and the second terminal 200), which is connected to the district center network management device 300 through the star network, through the communication unit 310. Further, the control unit 330 receives SCPC call establishment request information which is transmitted from the first terminal 100 through the communication unit 310 in response to the transmitted information.

The control unit 330 creates SCPC call establishment notice information based on the received SCPC call establishment request information. Here, the SCPC call establishment notice information includes session information (or session ID/session identification information), identification information of the second terminal 200 which is a target terminal, network usage starting time information, or network usage time in formation.

The control unit 330 transmits the created SCPC call establishment notice information to the second terminal 200 which is a target terminal to be SCPC connected with the first terminal 100 through the communication unit 310.

The control unit 330 receives the SCPC call establishment approval information which is transmitted from the second terminal 200 which is a target terminal through the communication unit 310 in response to the transmitted SCPC call establishment notice information. Here, the SCPC call establishment approval information includes session information or information representing whether to be approved.

The control unit 330 allocates an SCPC network resource for the SCPC link (or SCPC connection/access/call connection) between the first terminal 100 and the second terminal 200 based on the received SCPC call establishment approval information and an available frequency (or a resource) in the entire VSAT system (or entire satellite network) 10.

In this case, when approval rejection is included in the information representing whether to be approved which is included in the received the SCPC call establishment approval information, the control unit 330 transmits information indicating that the SCPC connection with the second terminal 200 is unavailable to the first terminal 100 through the communication unit 310 and the second terminal 200 receives and displays information indicating that SCPC connection is unavailable which is transmitted from the district center network management device 300 and then completes a process for the SCPC connection.

When approval permission (or approval acceptance) is included in the information representing whether to be approved which is included in the received SCPC call establishment approval information, the control unit 330 may allocate the SCPC network resource.

The control unit 330 creates SCPC call establishment information. Here, the SCPC call establishment information includes session information, identification information of the first terminal 100 which is a requesting terminal, identification information of the second terminal 200 which is a target terminal, information representing whether to be approved, network usage starting time information, network usage time information, SCPC network information (for example, including a subnet address of the terminal) of the first terminal 100 which is a requesting terminal, SCPC network information of the second terminal 200 which is a target terminal, information on a used frequency of the first terminal 100 which is a requesting terminal, information on a used frequency of the second terminal 200 which is a target terminal, information on a frequency bandwidth, information on DVB-S2 modulation/demodulation, and information on maximum output power.

The control unit 330 transmits the created SCPC call establishment information to the first terminal 100 which is a requesting terminal and the second terminal 200 which is a target terminal through the communication unit 310.

When a predetermined event happens, the control unit 330 creates SCPC call release notice information (for example, including session information, identification information of the first terminal 100 which is an SCPC call requesting terminal and identification information of the second terminal 200 which is a target terminal) in order to release (or end) an SCPC call (or SCPC connection) between the first terminal 100, which is a requesting terminal, and the second terminal 200, which is a target terminal, which are SCPC connected. Here, the predetermined event includes a case when a predetermined network usage time expires or a case when any one terminal among the SCPC connected terminals transmits an SCPC call releasing request to the district center network management device 300.

The control unit 330 transmits the created SCPC call release notice information to the first terminal 100 which is a requesting terminal and the second terminal 200 which is a target terminal through the communication unit 310.

The control unit 330 receives information indicating that the SCPC call release is completed which is transmitted from the terminals 100 and 200 in response to the transmitted SCPC call release notice information, through the communication unit 310.

After receiving all information indicating that the SCPC call release is completed from the terminals 100 and 200, the control unit 330 collects (or initializes) the SCPC network resource which is allocated for the SCPC connection between the terminals 100 and 200.

As described above, the plurality of terminals such as the first terminal 100 and the second terminal 200 performs a slave function for the SCPC and the district center network management device 300 performs a master function for the SCPC.

A mesh network may be formed in order to provide a terminal to terminal SCPC link based on the star network using the DVB-S2/RCS 1, 2.

As described above, it is possible to provide a call processing procedure for terminal to terminal SCPC connection in a VSAT system which is being operated by the star network.

Hereinafter, a control method of a VSAT system for hybrid operation of a star-mesh network according to an exemplary embodiment of the present invention will be described in detail with reference to FIGS. 1 to 8.

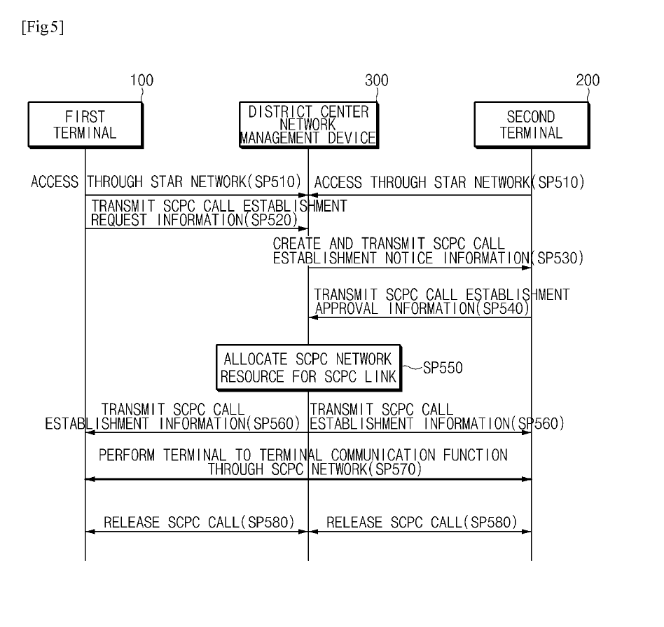

FIG. 5 is a signal flowchart illustrating a communication process of a VSAT system for hybrid operation of a star-mesh network according to a first exemplary embodiment of the present invention.

First, a plurality of terminals which includes a first terminal 100 and a second terminal 200 each accesses (or is connected to/logs on) a district center network management device 300 through a DVB-S2 or DVB-RCS network.

That is, the first terminal 100 and the second terminal 200 each collect satellite network information which is provided from the district center network management device 300 and perform synchronization based on the collected satellite network information to access the district center network management device 300 through the DVB-S2 or DVB-RCS network.

After completing the connection between the plurality of terminals and the district center network management device 300, the first terminal 100 and the second terminal 200 each transmit identification information (for example, including an ID or an MAC address of the terminal) of a terminal corresponding to each of the first terminal 100 and the second terminal 200, SCPC network information (for example, including a subnet address of the terminal), or SCPC service information (for example, including protocol information or port information) to the district center network management device 300.

For example, the first terminal 100 accesses the district center network management device 300 through the star network such as the DVB-S2 or DVB-RCS network.

For example, the second terminal 200 accesses the district center network management device 300 through the star network such as the DVB-S2 or DVB-RCS network (SP510).

Next, if the first terminal 100 among the plurality of terminals which is connected to the district center network management device 300 wants SCPC connection (or SCPC link) with the other terminal (for example, the second terminal 200) among the plurality of terminals, the first terminal 100 executes an application program (for example, an SCPC agent program) which is installed in advance in the first terminal 100 to create SCPC call establishment request information. Here, the SCPC call establishment request information includes identification information of the first terminal 100, identification information of the second terminal 200 which is the other terminal to be SCPC connected, network usage starting time information, network usage time information, or a requested bandwidth.

The first terminal 100 transmits the created SCPC call establishment request information to the district center network management device 300.

For example, when the SCPC agent program which is installed in advance in the first terminal 100 is executed while the first terminal 100 is connected to the district center network management device 300 through the star network such as the DVB-S2 or DVB-RCS network, the first terminal 100 receives information on the plurality of terminals (for example, including the first terminal 100 and the second terminal 200), which is connected to the district center network management device 300, which is transmitted from the district center network management device 300. Further, the first terminal 100 displays the information on the plurality of terminals which is connected to the district center network management device 300 which is received through the executed SCPC agent program. Further, when a specific terminal (for example, the second terminal 200) is selected among the displayed information on the plurality of terminals which is connected to the district center network management device 300, the first terminal 100 creates SCPC call establishment request information including identification information of the first terminal 100, identification information of the second terminal 200 to be SCPC connected, network usage starting time information, network usage time information, and a required bandwidth based on the information on the selected second terminal 200 and transmits the created SCPC call establishment request information to the district center network management device 300 (SP520).

Next, the district center network management device 300 receives the SCPC call establishment request information which is transmitted from the first terminal 100.

The district center network management device 300 creates SCPC call establishment notice information based on the received SCPC call establishment request information and transmits the created SCPC call establishment notice information to the second terminal 200 which is a target terminal to be SCPC connected with the first terminal 100. Here, the SCPC call establishment notice information includes session information (or session ID/session identification information), identification information of the second terminal 200 which is a target terminal, network usage starting time information, or network usage time information.

For example, the district center network management device 300 receives the SCPC call establishment request information which is transmitted from the first terminal 100, creates the SCPC call establishment notice information for the second terminal 200 to be SCPC connected based on the received SCPC call establishment request information, and transmits the created SCPC call establishment request information to the second terminal 200 (SP530).

Next, the second terminal 200 which accesses the district center network management device 300 receives the SCPC call establishment request information which is transmitted from the district center network management device 300 through the star network such as the DVB-S2 or DVB-RCS network.

The second terminal 200 transmits the SCPC call establishment approval information to the district center network management device 300 in response to the received SCPC call establishment request information. Here, the SCPC call establishment approval information includes session information or information representing whether to be approved.

For example, the second terminal 200 receives the SCPC call establishment request information which is transmitted from the district center network management device 300 and creates the SCPC call establishment approval information based on the received SCPC call establishment request information. Next, the second terminal 200 transmits the created SCPC call establishment approval information to the district center network management device 300 in response to the received SCPC call establishment request information (SP540).

Next, the district center network management device 300 receives the SCPC call establishment approval information which is transmitted from the second terminal 200 in response to the transmitted SCPC call establishment request information.

The district center network management device 300 allocates an SCPC network resource for the SCPC link (or SCPC connection/access/call connection) between the first terminal 100 and the second terminal 200 based on the received SCPC call establishment approval information and a frequency (or a resource) in the entire VSAT system (or entire satellite network) 10. In this case, the district center network management device 300 may allocate the SCPC network resource only when the approval permission is included in the information representing whether to be approved which is included in the received SCPC call establishment approval information.

That is, the district center network management device 300 checks a resource in the VSAT system 10 and allocates the SCPC network resource for the SCPC link between the first terminal 100 and the second terminal 200 based on the checked resource.

For example, the district center network management device 300 checks the frequency (or the resource) in the entire VSAT system 10 and allocates the available frequency as the SCPC network resource for the SCPC link between the first terminal 100 and the second terminal 200 based on the checked frequency (for example, including all of a frequency which is being used and an available frequency) after receiving the SCPC call establishment approval information transmitted from the second terminal 200 (SP550).

Next, the district center network management device 300 creates SCPC call establishment information and transmits the created SCPC call establishment information to the first terminal 100 and the second terminal 200. Here, the SCPC call establishment information includes session information, identification information of the first terminal 100 which is a requesting terminal, identification information of the second terminal 200 which is a target terminal, information representing whether to be approved, network usage starting time information, network usage time information, SCPC network information (for example, including a subnet address of the terminal) of the first terminal 100 which is a requesting terminal, SCPC network information of the second terminal 200 which is a target terminal, information on a used frequency of the first terminal 100 which is a requesting terminal, information on a used frequency of the second terminal 200 which is a target terminal, information on a frequency bandwidth, information on DVB-S2 modulation/demodulation, and information on maximum output power.

For example, the district center network management device 300 creates SCPC call establishment information and transmits the created SCPC call establishment information to the first terminal 100 and the second terminal 200 (SP560).

Next, the first terminal 100 and the second terminal 200 each receive the SCPC call establishment information which is transmitted from the district center network management device 300.

The first terminal 100 and the second terminal 200 performs a terminal to terminal communication function through the SCPC network based on the received SCPC call establishment information (SP570).

Next, when a predetermined event happens, the first terminal 100 and the second terminal 200 release the connected SCPC connection (or SCPC call) under the control of the district center network management device 300 (or in association with the district center network management device 300). Here, the predetermined event includes a case when a predetermined network usage time between the terminals 100 and 200 expires or a case when any one terminal between the terminals 100 and 200 transmits an SCPC call releasing request to the district center network management device 300.

For example, the first terminal 100 creates SCPC call release request information for SCPC call release (for example, including session information, the identification information of the first terminal 100 and the identification information of the second terminal 200) and transmits the created SCPC call release request information to the district center network management device 300. Next, the district center network management device 300 receives the SCPC release request information which is transmitted from the first terminal and creates SCPC call release notice information (for example, including the session information, the identification information of the first terminal 100, and the identification information of the second terminal 200) based on the received SCPC call release request information. Further, the district center network management device 300 transmits the created SCPC call release notice information to the first terminal 100 and the second terminal 200 which are SCPC connected. Next, each of the first terminal 100 and the second terminal 200 receives the SCPC call release notice information which is transmitted from the district center network management device 300 and completes the SCPC call release. Next, the district center network management device 300 collects the SCPC network resource which is allocated for the SCPC connection between the terminals 100 and 200 (SP580).

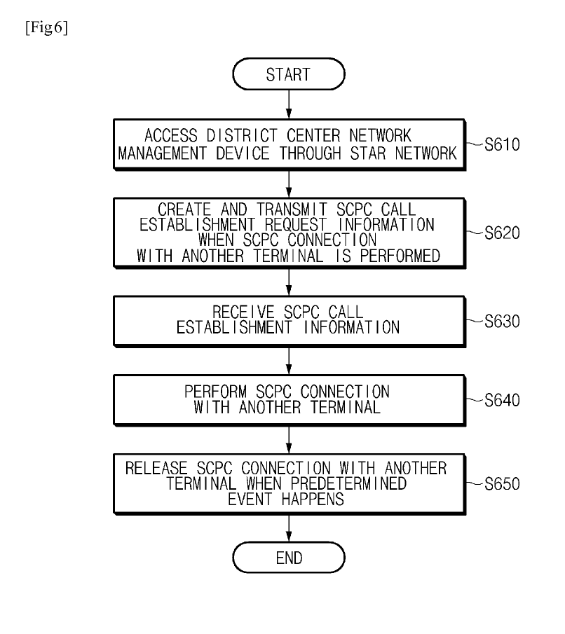

FIG. 6 is a flowchart illustrating a control method of a first terminal for hybrid operation of a star-mesh network according to a second exemplary embodiment of the present invention.

First, a first control unit 130 accesses (or is connected to/logs on) a district center network management device 300 through a DVB-S2 or the DVB-RCS.

That is, the first control unit collects satellite network information which is provided from the district center network management device 300 through the first communication unit 110 and performs synchronization with the district center network management device 300 based on the collected satellite network information to access the district center network management device 300 through the DVB-S2 or DVB-RCS network.

After completing the star network connection between the first control unit 130 and the district center network management device 300, the first control unit 130 transmits identification information (for example, including an ID or an MAC address of the terminal) of the first terminal 100, SCPC network information (for example, including a subnet address of the terminal), or SCPC service information (for example, including protocol information or port information) to the district center network management device 300 through a first communication unit 110 in step S610.

Next, when the first control unit 130 desires to perform SCPC connection (or SCPC link) with another terminal (for example, a second terminal 200) which accesses the district center network management device 300 through the star network while accessing the district center network management device 300 through the star network, the first terminal 130 creates SCPC call establishment request information. In this case, the first control unit 130 may also create the SCPC call establishment request information through an application program (for example, an SCPC agent program) which is installed in advance in the first terminal 100 (or through the executed application program), under the control (or manipulation) of the first terminal 100 by the user. Here, the SCPC call establishment request information includes identification information of the first terminal 100, identification information of a second terminal 200 which is the other terminal to be SCPC connected, network usage starting time information, network usage time information, or a requested bandwidth.

The first control unit 130 transmits the created SCPC call establishment request information to the district center network management device 300 through the first communication unit 110 in step S620.

Next, after normally performing whether to approve the SCPC call establishment for a second terminal 200 which is a target terminal through the district center network management device 300 based on the transmitted SCPC call establishment request information, the first control unit 130 receives the SCPC call establishment information (or SCPC connection establishment information) which is transmitted from the district center network management device 300) in response to the transmitted SCPC call establishment request information through the first communication unit 110. Here, the SCPC call establishment information includes session information, identification information of the first terminal 100 which is a requesting terminal, identification information of the second terminal 200 which is a target terminal, information representing whether to be approved, network usage starting time information, network usage time information. SCPC network information of the first terminal 100 which is a requesting terminal, SCPC network information of the second terminal 200 which is a target terminal, information on a used frequency of the first terminal 100 which is a requesting terminal, information on a used frequency of the second terminal 200 which is a target terminal, information on a frequency bandwidth, information on DVB-S2 modulation/demodulation, and information on maximum output power in step S630.

Next, the first control unit 130 performs a terminal to terminal communication function through the SCPC connection (or SCPC call/network/access/log-on) with the second terminal 200 which is a target terminal for the SCPC connection through the first communication unit 110 based on the received SCPC call establishment information in step S640.

Next, when a predetermined event happens, the first control unit 130 releases (or ends) the SCPC connection under the control (or management) of the district center network management device 300. Here, the predetermined event includes a case when a predetermined network usage time expires or a case when any one terminal among the SCPC connected terminals transmits an SCPC call releasing request to the district center network management device 300.

After completing the SCPC call release, the first control unit 130 transmits the SCPC call release completion information to the district center network management device 300 through the first communication unit 110 to notify (or inform) that the SCPC call release is completed in step S650.

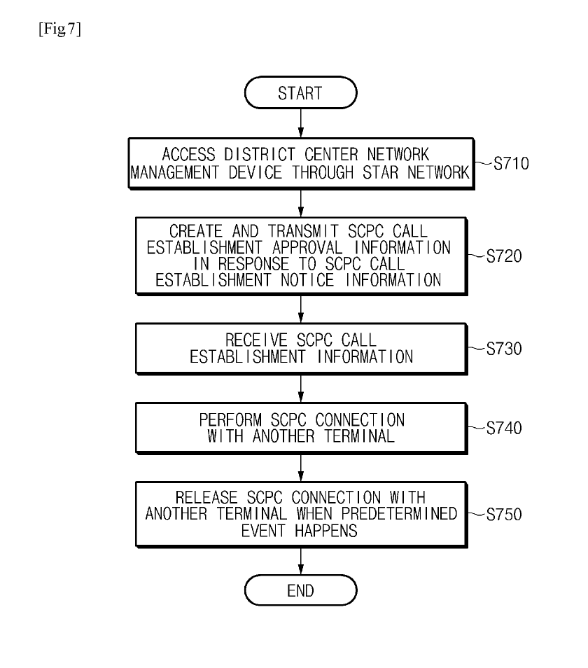

FIG. 7 is a flowchart illustrating a control method of a second terminal for hybrid operation of a star-mesh network according to a third exemplary embodiment of the present invention.

First, a second control unit 230 accesses (or is connected to/logs on) the district center network management device 300 through the DVB-S2 or DVB-RCS network.

After completing the star network connection between the second control unit 230 and the district center network management device 300, the second control unit 230 transmits identification information (for example, including an ID or an MAC address of the terminal) of the second terminal 200. SCPC network information (for example, including a subnet address of the terminal), or SCPC service information (for example, including protocol information or port information) to the district center network management device 300 through a second communication unit 210 in step S710.

Next, the second control unit 230 receives SCPC call establishment notice information which is transmitted from the district center network management device 300 through the second communication unit 210 while maintaining the star network connection between the second control unit 230 and the district center network management device 300. Here, the SCPC call establishment notice information includes session information (or session ID/session identification information), identification information of the second terminal 200 which is a target terminal, network usage starting time information, or network usage time information.

The second control unit 230 creates SCPC call establishment approval information in response to the received SCPC call establishment notice information and transmits the created SCPC call establishment approval information to the district center network management device 300 through the second communication unit 210. Here, the SCPC call establishment approval information includes session information, information representing whether to be approved (for example, including approval permission and approval rejection) in step S720.

Next, the second control unit 230 receives the SCPC call establishment information (or the SCPC connection establishment information) which is transmitted from the district center network management device 300 through the second communication unit 210 in response to the transmitted SCPC call establishment approval information. Here, the SCPC call establishment information includes session information, identification information of the first terminal 100 which is a requesting terminal, identification information of the second terminal 200 which is a target terminal, information representing whether to be approved, network usage starting time information, network usage time information, SCPC network information of the first terminal 100 which is a requesting terminal. SCPC network information of the second terminal 200 which is a target terminal, information on a used frequency of the first terminal 100 which is a requesting terminal, information on a used frequency of the second terminal 200 which is a target terminal, information on a frequency bandwidth, information on DVB-S2 modulation/demodulation, and information on maximum output power in step S730.

Next, the second control unit 230 performs terminal to terminal communication function through the SCPC connection with the first terminal 100 which is a requesting terminal for the SCPC connection through the second communication unit 210 based on the received SCPC call establishment information in step S740.

Next, when a predetermined event happens, the second control unit 230 releases (or ends) the SCPC connection under the control (or management) of the district center network management device 300. Here, the predetermined event includes a case when a predetermined network usage time expires or a case when any one terminal among the SCPC connected terminals transmits an SCPC call releasing request to the district center network management device 300.

After completing the SCPC call release, the second control unit 230 transmits the SCPC call release completion information to the district center network management device 300 through the second communication unit 210 to notify (or inform) that the SCPC call release is completed in step S750.

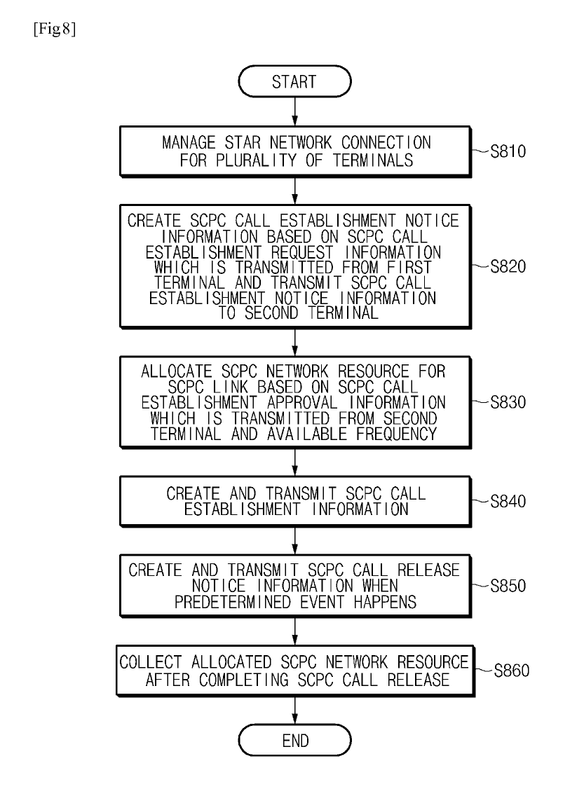

FIG. 8 is a flowchart illustrating a control method of a district center network management device for hybrid operation of a star-mesh network according to a fourth exemplary embodiment of the present invention.

First, a control unit 330 performs a log-on (or access/connection) management function for one or more (or a plurality of) terminals (for example, including a first terminal 100 and a second terminal 200) which try the access through the DVB-2 or DVB-RCS network in step S810.

Next, the control unit 330 receives SCPC call establishment request information which is transmitted from the first terminal 100 through a communication unit 310. Here, the SCPC call establishment request information includes identification information of the first terminal 100, identification information of the second terminal 200 which is the other terminal to be SCPC connected, network usage starting time information, network usage time information, or a requested bandwidth.

The control unit 330 creates SCPC call establishment notice information based on the received SCPC call establishment request information. Here, the SCPC call establishment notice information includes session information (or session ID/session identification information), identification information of the second terminal 200 which is a target terminal, network usage starting time information, or network usage time information.

The control unit 330 transmits the created SCPC call establishment notice information to the second terminal 200 which is a target terminal to be SCPC connected with the first terminal 100 through the communication unit 310 in step S820.

Next, the control unit 330 receives the SCPC call establishment approval information which is transmitted from the second terminal 200 which is a target terminal through the communication unit 310 in response to the transmitted SCPC call establishment notice information. Here, the SCPC call establishment approval information includes session information or information representing whether to be approved.

The control unit 330 allocates an SCPC network resource for the SCPC link (or SCPC connection/access/call connection) between the first terminal 100 and the second terminal 200 based on the received SCPC call establishment approval information and an available frequency (or a resource) in the entire VSAT system (or entire satellite network) 10.

That is, the control unit 330 checks a resource in the VSAT system 10 and allocates some of available frequencies as the SCPC network resource for the SCPC link between the first terminal 100 and the second terminal 200 based on the checked resource in step S830.

Next, the control unit 330 creates SCPC call establishment information. Here, the SCPC call establishment information includes session information, identification information of the first terminal 100 which is a requesting terminal, identification information of the second terminal 200 which is a target terminal, information representing whether to be approved, network usage starting time information, network usage time information, SCPC network information of the first terminal 100 which is a requesting terminal. SCPC network information of the second terminal 200 which is a target terminal, information on a used frequency of the first terminal 100 which is a requesting terminal, information on a used frequency of the second terminal 200 which is a target terminal, information on a frequency bandwidth, information on DVB-S2 modulation/demodulation, and information on maximum output power.

The control unit 330 transmits the created SCPC call establishment information to the first terminal 100 which is a requesting terminal and the second terminal 200 which is a target terminal through the communication unit 310 in step S840.

Next, when a predetermined event happens, the control unit 330 creates SCPC call release notice information (for example, including session information, identification information of the first terminal 100 which is an SCPC call requesting terminal and identification information of the second terminal 200 which is a target terminal) in order to release (or end) an SCPC call (or SCPC connection) between the first terminal 100, which is a requesting terminal, and the second terminal 200, which is a target terminal, which are SCPC connected. Here, the predetermined event includes a case when a predetermined network usage time expires or a case when any one terminal among the SCPC connected terminals transmits an SCPC call releasing request to the district center network management device 300.

The control unit 330 transmits the created SCPC call release notice information to the first terminal 100 which is a requesting terminal and the second terminal 200 which is a target terminal through the communication unit 310 in step S850.

Next, the control unit 330 receives information indicating that the SCPC call release is completed which is transmitted from each of the terminals 100 and 200 in response to the transmitted SCPC call release notice information, through the communication unit 310.

After receiving all information indicating that the SCPC call release is completed from the terminals 100 and 200, the control unit 330 collects the SCPC network resource which is allocated for the SCPC connection between the terminals 100 and 200 in step S860.

As described above, the exemplary embodiment of the present invention may efficiently provide data communication and/or video communication in a satellite communication system by forming a mesh network for providing a terminal to terminal SCPC link based on a star network using DVB-S2/RCS 1, 2.

As described above, the exemplary embodiment of the present invention may provide a call processing procedure for terminal to terminal SCPC connection in a VSAT system which is operated on a star network to stably provide real time multimedia data transmission and improve entire system operating efficiency.

Changes or modifications of the above description may be made by those skilled in the art without departing from the spirit and scope of the present invention. Accordingly, the exemplary embodiments disclosed herein are used not to limit but to describe the technical spirit of the present invention and the scope of the technical spirit of the present invention is not restricted by the exemplary embodiments. The protection scope of the present invention should be interpreted based on the following appended claims and it should be appreciated that all technical spirits included within a range equivalent thereto are included in the protection scope of the present invention.

What is claimed is:

1. A first terminal among a plurality of terminals which is connected to a district center network management device in a VSAT (very small aperture terminal) system, the first terminal comprising:
a communication unit which connects the first terminal to the district center network management device through a star network; and
a control unit which creates SCPC call establishment request information, transmits the created SCPC call establishment request information to the district center network management device through the communication unit, and performs SCPC connection with another terminal based on SCPC call establishment information which is transmitted from the district center network management device in response to the transmitted SCPC call establishment request information when intending to perform SCPC (single channel per carrier) connection with another terminal among the plurality of terminals.

2. The first terminal of claim 1, wherein the star network is a DVB-S2 or DVB-RCS network.

3. The first terminal of claim 1, wherein the SCPC call establishment request information includes at least one of identification information of the first terminal which includes the control unit, identification information of another terminal to be SCPC connected, network usage starting time information, network usage time information, and a requested bandwidth.

4. The first terminal of claim 1, wherein the SCPC call establishment information includes at least one of session information, identification information of the first terminal which is a requesting terminal, identification information of another terminal which is a target terminal, information representing whether to be approved, network usage starting time information, network usage time information, SCPC network information of the first terminal, SCPC network information of the other terminal, information on a used frequency of the first terminal, information on a used frequency of the other terminal, information on a frequency bandwidth, information on DVB-S2 modulation/demodulation, and information on maximum output power.

5. The first terminal of claim 1, wherein when a predetermined event happens, the control unit releases the SCPC connection with the other terminal under the control of the district center network management device.

6. The first terminal of claim 5, wherein the predetermined event includes a case when a predetermined network usage time expires or a case when any one terminal among the SCPC connected terminals transmits an SCPC call releasing request to the district center network management device.

7. A district center network management device which is connected to a plurality of terminals in a VSAT system, the device comprising:
a communication unit which connects the district center network management device to the plurality of terminals through a star network and receives SCPC call establishment request information which is transmitted from a first terminal among the plurality of terminals; and
a control unit which creates SCPC call establishment notice information based on the received SCPC call establishment request information, transmits the created SCPC call establishment notice information to a second terminal which is an SCPC call establishment target terminal through the communication unit, allocates an SCPC network resource for an SCPC link between the first terminal and the second terminal based on the SCPC call establishment approval information which is transmitted from the second terminal and an available frequency in the VSAT system in response to the transmitted SCPC call establishment notice information, and transmits the created SCPC call establishment information to the first terminal and the second terminal through the communication unit.

8. The device of claim 7, wherein the SCPC call establishment notice information includes at least one of session information, identification information of the second terminal which is a target terminal, network usage starting time information, and network usage time information.

9. The device of claim 7, wherein the SCPC call establishment approval information includes session information and information representing whether to be approved.

10. The device of claim 7, wherein when a predetermined event happens, the control unit creates SCPC call release notice information in order to release SCPC connection between the first terminal and the second terminal which are SCPC connected and transmits the created SCPC call release notice information to the first terminal and the second terminal, through the communication unit.

11. The device of claim 10, wherein the control unit receives information indicating that the SCPC call release is completed which is transmitted from the first terminal and the second terminal in response to the transmitted SCPC call release notice information, through the communication unit and then collects the allocated SCPC network resource for the SCPC link between the first terminal and the second terminal.

12. A control method of a first terminal among a plurality of terminals which is connected to a district center network management device in a VSAT system, the method comprising:
connecting the first terminal to the district center network management device based on a star network, through a communication unit;
creating SCPC call establishment request information, through a control unit, when intending to perform SCPC connection with another terminal among the plurality of terminals;
transmitting the created SCPC call establishment request information to the district center network management device, through the communication unit; and
performing SCPC connection with the other terminal based on the SCPC call establishment information which is transmitted from the district center network management device in response to the transmitted SCPC call establishment request information, through the control unit.

13. The method of claim 12, further comprising:
releasing the SCPC connection with the other terminal in association with the district center network management device, through the control unit, when a predetermined event happens; and
transmitting information indicating that SCPC call release is completed to the district center network management device, through the communication unit.

14. A control method of a district center network management device which is connected to a plurality of terminals in a VSAT system, the method comprising:
connecting the district center network management device to the plurality of terminals through a star network, through a communication unit;
creating SCPC call establishment notice information based on SCPC call establishment request information which is transmitted from a first terminal among the plurality of terminals, through a control unit;
transmitting the created SCPC call establishment notice information to a second terminal which is an SCPC call establishment target terminal, through the communication unit;
allocating an SCPC network resource for an SCPC link between the first terminal and the second terminal based on SCPC call establishment approval information which is transmitted from the second terminal and an available frequency in the VSAT system in response to the transmitted SCPC call establishment notice information, through the control unit;
creating SCPC call establishment information, through the control unit; and
transmitting the created SCPC call establishment information to the first terminal and the second terminal, through the communication unit.

15. The method of claim 14, further comprising:
creating SCPC call release notice information for releasing the SCPC connection between the first terminal and the second terminal which are SCPC connected, through the control unit, when a predetermined event happens;
transmitting the created SCPC call release notice information to the first terminal and the second terminal, through the communication unit; and
receiving information indicating that the SCPC call release is completed which is transmitted from the first terminal and the second terminal in response to the transmitted SCPC call release notice information through the communication unit and then collecting the allocated SCPC network resource for the SCPC link between the first terminal and the second terminal, through the control unit.
